(19) United States
(12) Patent Application Publication
(10) Pub. No.: US 2002/0098369 A1
(43) Pub. Date: Jul. 25, 2002

(54) PHASE CHANGE COMPOSITION

(76) Inventors: JASON L. SANDERS, INDIANAPOLIS, IN (US); GEORGE E. SEARS, INDIANAPOLIS, IN (US)

Correspondence Address: WAYNE W RUPERT, 111 LORD DRIVE, PO BOX 8012, CARY, NC, 275128012

(21) Appl. No.: 09/320,208

(22) Filed: May 26, 1999

(51) Int. Cl. B32B 5/16; C08K 3/08; B32B 27/30

(52) U.S. Cl. 428/484; 524/272; 524/274; 524/439; 524/440; 524/441; 428/328; 428/522; 428/209

(57) ABSTRACT

A phase change composition that is useful as a thermally conductive interface composition between a heat sink and an electronic component that includes:

(a) at least one ethylene polymer;

(b) at least one tackifier;

(c) at least one wax; and

(d) at least one thermally conductive metal filler, wherein the composition is a solid at 25° C., begins to melt at about 35 to 80° C., and turns to a liquid at about 45 to 110° C.

### BACKGROUND OF THE INVENTION

The present invention relates to a phase change composition useful in the electronics industry.

The use of thermally conductive materials as interface materials between heat sinks and electronic components is generally known. However, the commercially available thermally conductive materials suffer from having a grease-like or gel-like consistency at room temperature and a tacky surface that makes them difficult to handle by the end-user. It would be advantageous to have a thermally conductive material that is a self-supporting solid at room temperature and that is non-tacky.

### SUMMARY OF THE INVENTION

According to the present invention there is provided a phase change composition that is particularly useful as a thermally conductive interface material between a heat sink and an electronic component such as an integrated circuit package. The phase change composition includes:

(a) at least one ethylene polymer, preferably 5 to 10 weight percent;

(b) at least one tackifier, preferably 5 to 10 weight percent;

(c) at least one wax, preferably 5 to 10 weight percent; and

(d) at least one thermally conductive metal additive, preferably 70 to 85 weight percent,

wherein the weight percents are based on the total amount of components (a)-(d). The composition is a solid at 25° C., begins to melt at about 35 to 80° C., preferably about 35-45° C., and turns to a liquid at about 45 to 110° C., preferably about 45-55° C.

The phase change composition absorbs heat during the phase change and acts as a thermal conductor in its liquid state. The non-tacky phase change composition has low thermal resistance and can be made into a self-supporting die-cuttable film that can be cut with clean, non-tacky edges.

There is also provided a laminate that includes a heat sink, an electronic component and the phase change composition disposed between the heat sink and the electronic component.

### DETAILED DESCRIPTION OF THE PREFERRED EMBODIMENTS

The ethylene polymer, tackifier, wax and metal additive are referred to herein as the “primary components”.

The ethylene polymer is any thermoplastic polymer that is derived at least in part from an ethylene monomer. Illustrative polymers include polyethylene and copolymers such as ethylene/vinyl ester (such as ethylene/vinyl acetate), ethylene/methyl acrylate, ethylene/butyl acrylate, ethylene/propylene and ethylene/ethyl acrylate. Particularly preferred are ethylene/vinyl acetate (“EVA”) copolymers, especially those available from DuPont under the trade designation ELVAX. Such EVA copolymers typically include 18-40 percent by weight ethylene vinyl acetate. The ethylene polymer can be present in the composition in an amount of 5 to 10, preferably 7 to 9, weight percent based on the total amount of the primary components.

Suitable tackifiers are those that are well known in the hot melt adhesive art. Such tackifiers typically are hydrocarbon resins and natural and synthetic rosins. Examples of rosins include gum rosin, wood rosin, tall-oil rosin, distilled rosin, hydrogenated rosin, dimerized rosin, polymerized rosin, glycerol rosin ester and pentaerythritol rosin ester. Examples of hydrocarbon resins include those derived from natural and synthetic terpenes, C₅ resins, C₉ resins and mixtures thereof. The tackifier can be present in the composition in an amount of 5 to 10, preferably 7 to 9, weight percent based on the total amount of the primary components.

Terpene resin tackifiers, sometimes called polyterpene resins, result from polymerization of terpene hydrocarbons, such as bicyclic monoterpene known as pinene, in the presence of Friedel-Crafts catalysts at moderately low temperature. Suitable terpene resin may include polymerized beta-pinenes. Terpene phenolic resin tackifiers may include the product resulting from the condensation of bicyclic terpene (in an acidic medium) or terpene alcohol with phenol.

Suitable aliphatic unsaturated hydrocarbon resin tackifiers may be prepared by polymerizing unsaturated hydrocarbon monomer mixtures, or streams formed by cracking petroleum. These compounds typically include the mixture of a 5 carbon to 9 carbon stream from petroleum refining, commonly referred to as C₅-C₉ stream. Hence, the resins prepared from such a stream are commonly referred to as C₅-C₉ resins. The components of a C₅-C₉ monomer stream include aliphatic and aromatic hydrocarbon compounds, both normal and branch, in which the number of carbons does not exceed 9.

Other suitable resin tackifiers include hydrocarbon resins substantially free of polymerized aromatics prepared by polymerizing the monomer mixture of the five carbon atom monomer olefin streams from petroleum refining, the monomers being primarily aliphatic. These resins are commonly referred to as C₅ resins. The primary monomers of C₅ resins are di and monoolefins of both natural and branched 5 carbon components and the mono-olefins of 6 carbon components.

C₅-C₉ resins that are modified with aromatic compounds to produce aromatic-aliphatic resins are also useful. Typical examples of aromatic modifiers include styrenic monomers such as styrene, α-methylstyrene, vinyl toluene, methoxystyrene, t-butylstyrene, chlorostyrene and indene monomers.

Suitable terpene resin tackifiers also include polyterpene resins derived from α-pinene, β-pinene, and monocyclic terpene such as dipentene.

Commercially available examples of tackifiers include rosins from Hercules, Inc. under the trade designations PEXITE, STAYBELITE, and FORAL and from Arizona Chemical Co. under the trade designation SYLVATAC; terpenes and C₅ resins from Arizona Chemical Co. under the trade designation ZONATAC and from Goodyear under the trade designation WINGTACK; and terpenes from Hercules, Inc. under the trade designation PICCOLYTE.

Suitable waxes are those that are well known in the hot melt adhesive art. Illustrative waxes include microcrystalline, paraffin, polyethylene, polypropylene, Fischer-Tropsch, carnauba, mineral, petrolatum, vegetable, candelilla, spermaceti, bees, fatty alcohol and fatty acid. The wax can be present in the composition in an amount of 5 to 10, preferably 7 to 9, weight percent based on the total amount of the primary components.

A unique feature of the invention is that the desired phase change characteristics are obtained by the blend of the three polymers. Individually, none of the polymers have the desired phase change. For example, ELVAX 40W has a reported melting temperature of 130° C., WINGTACK 86 has a reported melting temperature of 86° C., and R-2351 paraffin wax has a reported melting temperature of 46° C.

The thermally conductive metal additive enables the phase change composition to act as a thermal conductor in its liquid state. Illustrative metal additives include aluminum, boron, silver, copper, gold, platinum and compounds thereof such as oxides and nitrides. Preferred are aluminum, aluminum nitride and boron nitride, with aluminum being particularly preferred. More than one type of metal additive can be included. The additive can be in any form, but preferably is in the form of a powder that is dispersible in the melted polymers. The metal additive can be present in the composition in an amount of 70 to 85, preferably 75 to 80, weight percent, based on the primary components.

The composition of the invention can also include an antioxidant. Antioxidants that may be used include tris(di-t-butyl-p-hydroxybenzyl)-trimethyl-benzene (IONOX 330), alkylated hisphenol (NAUGAWHITE), zinc dibutyl dithiocarbamate (BUTYL ZIMATE), 4,4′-methylene bis (2,6-di-tert butylphenol) (Ethyl 702), tetrakis[methylene(3,5,di,tert,butyl,4,hydroxyhydro cinamate)methane](IRGANOX 1010), lauryl stearyl thiodipropionate (PLASTANOX 1212), dilauryl 3,3′-thiodipropionate (PLASTANOX LTDP) 2,6-di-tert-butyl-p-cresol (BHT) and the like. Other representative hindered phenols include: 1,3,5-trimethyl 2,4,6 tris ( 3,5-di-tert-butyl-4-hydroxybenzyl)benzene, pentaerythrityl tetrakis-3(3,5-di-tert-butyl-hydroxyphenol)-propionate, n-octadecyl-3(3,5-di-tert-butyl-4-hydroxyphenol)propionate, 4,4′-methylene bis (2,6-tert-butyl phenol), 4,4′-thiobis (6-tert-butyl-o-cresol), 2,6-di-tert-butyl phenol, 6-(4-hydroxy phenoxy)-2,4-bis (n-octyl-thio)-1,3,5triazine, di-n-octylthio)ethyl 3,5-di-tert-butyl-4-hydroxybenzoate, and sorbitol hexa [3-(3,-di-tert-butyl-4-hydroxyphenyl)propionate].

The composition of the invention is a homogenous mixture made by melt blending the ethylene polymer, tackifier and wax and then adding the metal filler. The molten mixture then is cooled into any desired shape for subsequent use.

The composition is particularly effective as an interface material between a heat sink and an integrated circuit package. In this application, the phase change composition is formed into a thin film and then the film is placed on a support layer (such as a wire mesh or cloth, plastic film or mesh, glass fiber cloth or fabric mesh or cloth) and exposed to hot rollers in order to impregnate the support layer with the phase change material. The impregnated mesh is then attached between a heat sink and an integrated circuit package. Alternatively, the phase change composition could be applied as a distinct film to one or both sides of the support layer.

### EXAMPLE 1

A phase change composition was made by melt blending 500 g EVA copolymer (ELVAX 40W commercially available from DuPont), 500 g tackifier (WINGTACK 86 commercially available from Goodyear), 600 g paraffin wax, 8 g IRGANOX 1010 and 6000 g aluminum.

### EXAMPLE 2

A phase change composition was made by melt blending 500 g EVA copolymer (ELVAX 40W commercially available from Du Pont), 500 g tackifier (EASTOTAC Resin H-100E commercially available from Eastman), 600 g microcrystalline wax (ULTRAFLEX AMBER commercially available from Bareco Products), 8 g IRGANOX 1010 and 6000 g aluminum.

### EXAMPLE 3

A phase change composition was made by melt blending 500 g EVA copolymer (Elvax 240 commercially available from Du Pont), 500 g tackifier (“Eastotac” Reshin H-115E commercially available from Eastman), 600 g microcrystalline wax (Ultraflex Amber commercially available from Bareco Products), 8 g IRGANOX 1010 and 6000 g aluminum.

What is claimed is:

1. A composition comprising:
(a) 5 to 10 weight percent of at least one ethylene polymer;
(b) 5 to 10 weight percent of at least one tackifier;
(c) 5 to 10 weight percent of at least one wax; and
(d) 70 to 85 weight percent of at least one thermally conductive metal filler, wherein the weight percents are based on the total amount of components (a)-(d).

2. A composition according to claim 1 wherein the ethylene polymer is selected from polyethylene, ethylene/vinyl ester copolymer, ethylene/methyl acrylate copolymer, ethylene/butyl acrylate copolymer, ethylene/propylene copolymer and ethylene/ethyl acrylate copolymer.

3. A composition according to claim 1 wherein the tackifier is selected from natural or synthetic rosin and hydrocarbon resins derived from at least one of a natural terpene, synthetic terpene, C₅ resin, and C₉ resin.

4. A composition according to claim 1 wherein the wax is selected from microcrystalline, paraffin, polyethylene polypropylene, Fischer-Tropsch, carnauba, mineral, petrolatum, vegetable, candelilla, spermaceti, bees, fatty alcohol and fatty acid.

5. A composition according to claim 1 wherein the metal filler is selected from aluminum, boron, silver, copper, gold and platinum and compounds thereof.

6. A composition according to claim 1 wherein the ethylene polymer comprises an ethylene/vinyl acetate copolymer metal filler comprises aluminum.

7. A composition according to claim 1 wherein the composition is a solid at 25° C., begins to melt at about 35 to 80° C. and turns to a liquid at about 45 to 110° C.

8. A composition according to claim 7 wherein the composition begins to melt at about 35 to 45° C. and begins to turn to a liquid at about 45 to 55° C.

9. A film comprising a support layer and a phase change composition wherein the phase change composition comprises:
(a) 5 to 10 weight percent of at least one ethylene polymer;
(b) 5 to 10 weight percent of at least one tackifier;
(c) 5 to 10 weight percent of at least one wax; and
(d) 70 to 85 weight percent of at least one thermally conductive metal filler, wherein the weight percent are based on the total amount of components (a)-(d).

10. A film according to claim 9 wherein the ethylene polymer is selected from polyethylene, ethylene/vinyl ester copolymer, ethylene/methyl acrylate copolymer, ethylene/butyl acrylate copolymer, ethylene/propylene copolymer and ethylene/ethyl acrylate copolymer.

11. A film according to claim 9 wherein the metal filler is selected from aluminum, boron, silver, copper, gold and platinum and compounds thereof.

12. A film according to claim 9 wherein the ethylene polymer comprises an ethylene/vinyl acetate copolymer and the metal filler comprises aluminum.

13. A film according to claim 9 wherein the composition is a solid at 25° C., begins to melt at about 35 to 80° C., and turns to a liquid at about 45 to 110° C.

14. An interface material positioned between an electronic component and a heat sink wherein the interface material comprises:
(a) at least one ethylene polymer;
(b) at least one tackifier;
(c) at least one wax; and
(d) at least one thermally conductive metal filler.

15. An interface material according to claim 14 wherein the material is a solid at 25° C., begins to melt at about 35 to 80° C., and turns a liquid at about 45 to 110° C.

16. An interface material according to claim 14 wherein the ethylene polymer comprises an ethylene/vinyl acetate copolymer and the metal filler comprises aluminum.

17. An interface material according to claim 14 wherein the ethylene polymer is selected from polyethylene, ethylene/vinyl ester copolymer, ethylene/methyl acrylate copolymer, ethylene/butyl acrylate copolymer, ethylene/propylene copolymer and ethylene/ethyl acrylate copolymer.

18. An interface material according to claim 14 comprising 5 to 10 weight percent ethylene polymer, 5 to 10 weight percent tackifier, 5 to 10 weight percent wax and 70 to 85 weight percent metal filler, wherein the weight percents are based on the total amount of components (a)-(d).

19. A laminate comprising a heat sink, an electronic component and an interface material disposed between the heat sink and the electronic component, wherein the interface material comprises:
(a) at least one ethylene polymer;
(b) at least one tackifier;
(c) at least one wax; and
(d) at least one thermally conductive metal filler.
